(19) United States
(12) Patent Application Publication
(10) Pub. No.: US 2016/0254533 A1
(43) Pub. Date: Sep. 1, 2016

(54) MAKING LITHIUM SECONDARY BATTERY ELECTRODES USING AN ATMOSPHERIC PLASMA

(71) Applicant: GM GLOBAL TECHNOLOGY OPERATIONS LLC, Detroit, MI (US)

(72) Inventor: Xiaohong Q. Gayden, West Bloomfield, MI (US)

(73) Assignee: GM GLOBAL TECHNOLOGY OPERATIONS LLC, DETROIT, MI (US)

(21) Appl. No.: 15/028,783

(22) PCT Filed: Oct. 16, 2013
(86) PCT No.: PCT/CN2013/085330

§ 371 Date: Apr. 12, 2016

(51) Int. Cl. H01M 4/1391; H01M 4/131; H01M 4/04

(52) U.S. Cl. CPC H01M 4/1391; H01M 4/0404; H01M 4/0407; H01M 4/0423; H01M 4/131

(57) ABSTRACT

The manufacture of electrode members for lithium-ion electrochemical cells and batteries is more efficient using an atmospheric plasma stream in carrying, heating, and directing current collector and electrode materials for deposition on thin sheet substrates. Particles of conductive metals are heated and partially melted in the plasma and deposited as current collector films for active electrodes (and reference electrodes) at relatively low temperatures (<100° C.) on separator sheets. Particles of lithium-ion accepting and releasing electrode materials are combined with smaller portions of conductive metals for plasma heating and deposition on current collector layers in forming positive and negative electrodes for lithium-ion cells. Such use of the atmospheric plasma avoids the need for the use of organic binders and wet deposition practices in electrode layer manufacture, and enables the deposition of thicker, lower stress layers of active electrode materials for higher cell capacity and power.

### TECHNICAL FIELD

This disclosure pertains to methods for forming thin layers of electrode materials on a cell-member surface in the manufacture of cell components and the assembly of the components into cells for lithium batteries such as lithium-ion batteries or lithium-sulfur batteries. More specifically, this disclosure pertains to the use of an atmospheric plasma in the deposition of layers of current collector films, working electrode materials and reference electrode materials in the manufacture of such cells.

### BACKGROUND OF THE INVENTION

Assemblies of lithium-ion battery cells are finding increasing applications in providing motive power in automotive vehicles. Lithium-sulfur cells are also candidates for such applications. Each lithium-ion cell of the battery is capable of providing an electrical potential of about three to four volts and a direct electrical current based on the composition and mass of the electrode materials in the cell. The cell is capable of being discharged and re-charged over many cycles. A battery is assembled for an application by combining a suitable number of individual cells in a combination of electrical parallel and series connections to satisfy voltage and current requirements for a specified electric motor. In a lithium-ion battery application for an electrically powered vehicle, the assembled battery may, for example, comprise up to three hundred individually packaged cells that are electrically interconnected to provide forty to four hundred volts and sufficient electrical power to an electrical traction motor to drive a vehicle. The direct current produced by the battery may be converted into an alternating current for more efficient motor operation.

The batteries may be used as the sole motive power source for electric motor driven electric vehicles or as a contributing power source in various types of hybrid vehicles, powered by a combination of an electric motor(s) and hydrocarbon-fueled engine. There is a desire to reduce the cost of producing the respective elements of each lithium-ion electrochemical cell.

In these automotive applications, each lithium-ion cell typically comprises a negative electrode layer (anode, during cell discharge, a positive electrode layer (cathode, during cell discharge), a thin porous separator layer interposed in face-to-face contact between parallel facing electrode layers, and a liquid, lithium-containing, electrolyte solution filling the pores of the separator and contacting the facing surfaces of the electrode layers for transport of lithium ions during repeated cell discharging and re-charging cycles. Each electrode is prepared to contain a layer of an electrode material, typically deposited on a thin layer of a metallic current collector.

For example, the negative electrode material has been formed by depositing a thin layer of graphite particles, often mixed with conductive carbon black, and a suitable polymeric binder onto one or both sides of a thin foil of copper which serves as the current collector for the negative electrode. The positive electrode also comprises a thin layer of resin-bonded, porous particulate, lithium-metal-oxide composition bonded to a thin foil of aluminum which serves as the current collector for the positive electrode. Thus, the respective electrodes have been made by dispersing mixtures of the respective binders and active particulate materials in a suitable liquid, depositing the wet mixture as a layer of controlled thickness on the surface of a current collector foil, and drying, pressing, and fixing the resin bonded electrode particles to their respective current collector surfaces. The positive and negative electrodes may be formed on current collector sheets of a suitable area and shape, and cut (if necessary) and folded or otherwise shaped for assembly into lithium-ion cell containers with suitable porous separators and a liquid electrolyte. But such processing of the wet mixtures of electrode materials requires extended periods of manufacturing time. And the thickness of the respective active material layers (which limits the electrical capacity of the cell) is limited to minimize residual stress during drying of the electrode material.

A lithium-ion cell, or a group of such cells, may also require the insertion of a reference electrode layer or cell, composed for use in assessing the performance of the cell during its repeating discharge/re-charge cycling. Reference electrode materials are prepared either using conductive metal wires, such as copper, or by using wet dispersions of reference electrode particles, conductive materials, and binder materials.

The preparation and deposition of the wet mixtures of electrode materials on current collector foils is now seen as time-consuming, cell capacity limiting, and expensive. It is recognized that there is a need for a simpler and more efficient practice for making layers of electrode materials for lithium-ion battery cells.

### SUMMARY OF THE INVENTION

In accordance with practices of this invention, particles of materials for use in lithium-ion cell electrode structures are deposited on and bonded to a selected substrate surface for the electrode structure using an atmospheric plasma source. As further described below in this specification, the particles are composed of one or more of silicon, silicon alloys, SiOx, Li—Si alloys, graphite, and lithium titanate, selected for use as the active electrode material for the anode (negative electrode) of the lithium-ion cell. The particles are coated with or mixed with a conductive metal such as aluminum, copper, copper alloys, tin, tin alloys, or others. The coating of conductive metal (or intermixed particles of conductive metal) is selected and used in an amount to partially melt in the atmospheric plasma and to bond the electrode material particles to a current collector foil for lithium-ion cell or to a porous separator layer for the cell. Upon re-solidification, the conductive metal bonds the electrode material particles to each other in a porous layer and to an underlying current collector substrate. The conductive metal constituent is used in an amount to securely bond the active electrode material particles to the cell-member substrate as a porous layer that can be infiltrated with a liquid electrolyte to be used in an assembled lithium-ion cell. Typically, the conductive metal may be used in an amount up to about thirty weight percent of the active material constituent(s). In accordance with practices of this invention, the conductive metal/particle composition consists exclusively of such active material for the electrode, free of any liquid vehicle or organic binder material.

In many embodiments of the invention, the negative electrode material will be deposited on a thin copper foil as the substrate, and the material particles for the anode may be coated with copper or mixed with copper particles. Similarly, and separately, particles of positive electrode materials, such as lithium-manganese-oxide, lithium-nickel-oxide, and/or lithium-cobalt-oxide may be coated with aluminum (or mixed with particles of aluminum) and deposited, using the atmospheric plasma, on a thin aluminum foil as the current collector substrate.

Electrode material/conductor particles of suitable micron-size are supplied or delivered (for example) by gravity into a gas stream, such as an air stream or a stream of nitrogen or an inert gas, flowing within an upstream tubular delivery tube of an atmospheric plasma generator. As stated, the particles may consist, for example, of copper-coated, silicon-containing particles for forming an anode layer for a lithium-ion cell. Or a mixture of copper particles and silicon-containing particles may be directed into the gas stream. The particles are dispersed into the gas stream and carried into the nozzle of the plasma generator where the flowing gas molecules are momentarily converted into plasma by a suitable electrical discharge at the nozzle outlet. The plasma heats the moving dispersed particles to soften and partially melt the metallic, electrical conductor particles and/or coating.

The atmospheric plasma stream is directed against the substrate surface in, for example, a suitable sweeping path so as to deposit the active electrode material as a porous layer of conductive metal-bonded particles adhering to the cooperating metal foil substrate. Either, or both, of the plasma and substrate may be in motion during the deposition of the active electrode material. In many applications of the process, the layer will be deposited in one or more coating steps with a total uniform thickness of up to about 200 micrometers. The thickness of the deposit of active electrode material usually depends on the intended electrical generating capacity of the cell.

Sometimes the active electrode materials for lithium-ion cells may be composed to contain two or more constituents. For example, the negative electrode material may consist of a mixture of silicon and other particles, and the positive electrode material may contain a mixture of lithium-metal-oxide compounds. In accordance with practices of the invention, component constituents of an active electrode material may be delivered to an atmospheric plasma generator such that the applied coating of active electrode material has a uniform composition throughout its thickness, or an electrode composition that is varied throughout its micrometer scale thickness. In practices of the invention for preparation of metal foil-supported electrode bodies, it will often be preferred to deposit the electrode material as a layer with suitable porosity for infiltration of the layer by the lithium-containing electrolyte in the operation of the assembled cell. Where the finished coating layer is built up of two or more plasma deposited layers, the individual layers may vary in composition, porosity, and/or morphology of the deposited material. The electrodes function upon suitable contact of the electrode material by the electrolyte and transfer of lithium into and from each electrode during the cycling of the cell.

The atmospheric plasma method may also be used in the preparation of a current collector film on the surface of an electrode layer supported by a porous separator membrane. In this embodiment copper, aluminum, tin or tin alloy particles (for example) may be deposited in a desired layer of relatively low porosity using the described atmospheric plasma.

In another embodiment, the atmospheric plasma may be used to form reference electrode layers for use in combination with working cells of a lithium-ion battery. In this embodiment, the plasma method is used to deposit a dense copper conductor layer (for example) onto a surface of thin porous separator member as substrate. A removable patterned mask may be used to define the formation of a thin, narrow copper or aluminum conductor strip on the separator. For example, the conductor strip may be about ten micrometers thick, five to fifteen micrometers wide, and about five millimeters long. After removal of the mask and the attachment of a metal conductor tab to the deposited metal, the coated separator may be placed in an assembly of operating cell element layers, located so as to function as a reference electrode. Lithium metal is then electrochemically deposited on the conductor layer from working electrodes in the assembly to complete formation of a reference electrode to track the performance of the cell assembly.

In general, practices of the invention may be conducted under ambient conditions and without preheating of either the substrate layer or the solid particles supplied to the atmospheric plasma generator. Although the coating particles are momentarily heated in the atmospheric plasma, they are typically deposited on the substrate material without heating the substrate to a temperature as high as 150° C.

Other objects and advantages of the invention will become apparent from the further illustrations of practices of the invention in the following sections of this specification.

### BRIEF DESCRIPTION OF THE DRAWINGS

FIG. 1 is an enlarged schematic illustration of the anode, separator, and cathode elements of a lithium-ion cell depicting an anode and a cathode each consisting of a metal current collector carrying a layer of deposited conductive metal/active electrode material formed in accordance the atmospheric plasma deposition process of this invention.

FIG. 2 is a schematic illustration depicting a powder delivery system and atmospheric plasma nozzle applying a layer of conductive metal/active electrode material to a metallic current collector foil.

FIG. 3 is a schematic illustration of the formation of a copper conductor film on a porous separator membrane as a first step in the formation of a reference electrode for use in combination with a cell of a lithium-ion battery.

### DESCRIPTION OF PREFERRED EMBODIMENTS

An active lithium-ion cell material is an element or compound which accepts or intercalates lithium ions, or releases or gives up lithium ions in the discharging and re-charging cycling of the cell. A few examples of suitable electrode materials for the negative electrode of a lithium ion cell are graphite, silicon, alloys of silicon with lithium or tin, silicon oxides (SiOx), and lithium titanate. Examples of positive electrode materials include lithium manganese oxide, lithium nickel oxide, lithium cobalt oxide and other lithium-metal-oxides. Other materials are known and commercially available. One or more of these materials may be used in an electrode layer. In accordance with practices of this invention as will be described in more detail below in this specification, the respective electrode materials are initially in the form of submicron to micron-size particles, in the range of tens of nanometers to tens of microns, that are either coated with a thin film of a conductive metal or are mixed with particles of a conductive metal.

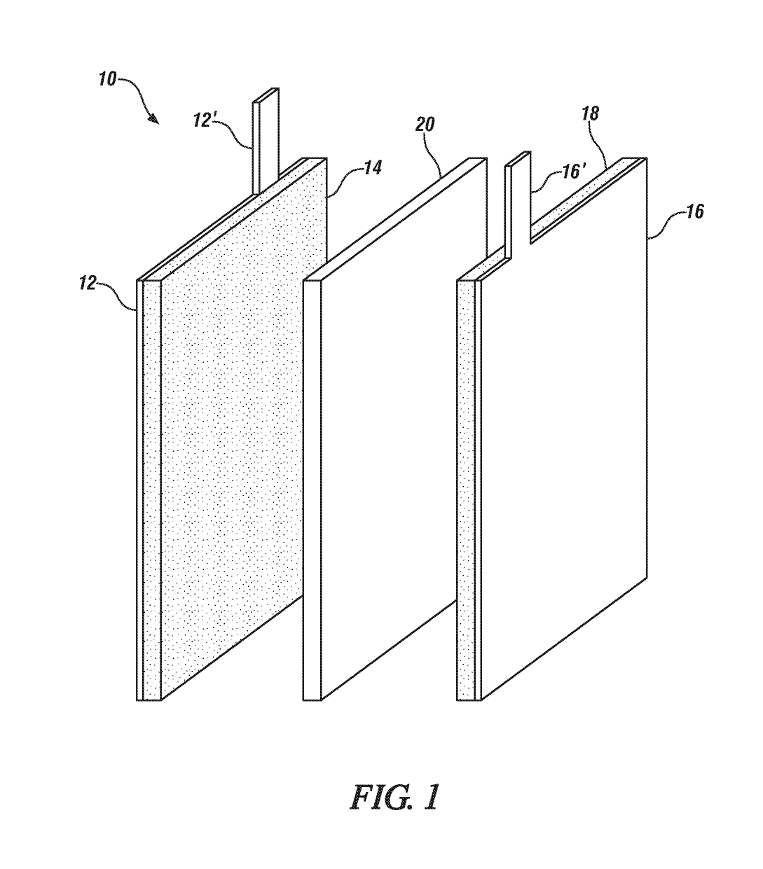

FIG. 1 is an enlarged schematic illustration of a spaced-apart assembly 10 of three solid members of a lithium-ion electrochemical cell. The three solid members are spaced apart in this illustration to better show their structure. The illustration does not include an electrolyte solution whose composition and function will be described in more detail below in this specification. Practices of this invention are typically used to manufacture electrode members of the lithium-ion cell when they are used in the form of relatively thin layered structures.

In FIG. 1, a negative electrode consists of a relatively thin conductive metal foil current collector 12. The negative electrode current collector 12 is typically formed of a thin layer of copper. The thickness of metal foil current collector is suitably in the range of about ten to twenty-five micrometers. The current collector 12 has a desired two-dimensional plan-view shape for assembly with other solid members of a cell. Current collector 12 is illustrated as rectangular over its principal surface, and further provided with a connector tab 12′ for connection with other electrodes in a grouping of lithium-ion cells to provide a desired electrical potential or electrical current flow.

Deposited on the negative electrode current collector 12 is a thin, porous layer of negative electrode material 14. As illustrated in FIG. 1, the layer of negative electrode material 14 is typically co-extensive in shape and area with the main surface of its current collector 12. The electrode material has sufficient porosity to be infiltrated by a liquid, lithium-ion containing electrolyte. In accordance with embodiments of this invention, the thickness of the rectangular layer of negative electrode material may be up to about two hundred micrometers so as to provide a desired current and power capacity for the negative electrode. As will be further described, the negative electrode material may be applied layer by layer so that one large face of the final block layer of negative electrode material 14 is bonded to a major face of current collector 12 and the other large face of the negative electrode material layer 14 faces outwardly from its current collector 12.

A positive electrode is shown, comprising a positive current collector foil 16 and a coextensive, overlying, porous deposit of positive electrode material 18. Positive current collector foil 16 also has a connector tab 16′ for electrical connection with other electrodes in other cells that may be packaged together in the assembly of a lithium-ion battery. The positive current collector foil 16 and its coating of porous positive electrode material 18 are typically formed in a size and shape that are complementary to the dimensions of an associated negative electrode. In the illustration of FIG. 1, the two electrodes are identical in their shapes and assembled in a lithium-ion cell with the major outer surface of the negative electrode material 14 facing the major outer surface of the positive electrode material 18. The thicknesses of the rectangular positive current collector foil 16 and the rectangular layer of positive electrode material 18 are typically determined to complement the negative electrode material 14 in producing the intended electrochemical capacity of the lithium-ion cell. The thicknesses of current collector foils are typically in the range of about 10 to 25 micrometers. And the thicknesses of the electrode materials, formed by this dry atmospheric plasma process are up to about 200 micrometers.

A thin porous separator layer 20 is interposed between the major outer face of the negative electrode material layer 14 and the major outer face of the positive electrode material layer 18. In many battery constructions, the separator material is a porous layer of a polyolefin, such as polyethylene or polypropylene. Often the thermoplastic material comprises inter-bonded, randomly oriented fibers of PE or PP. The fiber surfaces of the separator may be coated with particles of alumina, or other insulator material, to enhance the electrical resistance of the separator, while retaining the porosity of the separator layer for infiltration with liquid electrolyte and transport of lithium ions between the cell electrodes. The separator layer 20 is used to prevent direct electrical contact between the negative and positive electrode material layers 14, 18, and is shaped and sized to serve this function. In the assembly of the cell, the opposing major outer faces of the electrode material layers 14, 18 are pressed against the major area faces of the separator membrane 20. A liquid electrolyte is injected into the pores of the separator and electrode material layers.

The electrolyte for the lithium-ion cell is often a lithium salt dissolved in one or more organic liquid solvents. Examples of salts include lithium hexafluorophosphate (LiPF₆), lithium tetrafluoroborate (LiBF₄), lithium perchlorate (LiClO₄), lithium hexafluoroarsenate (LiAsF₆), and lithium trifluoroethanesulfonimide. Some examples of solvents that may be used to dissolve the electrolyte salt include ethylene carbonate, dimethyl carbonate, methylethyl carbonate, propylene carbonate. There are other lithium salts that may be used and other solvents. But a combination of lithium salt and solvent is selected for providing suitable mobility and transport of lithium ions in the operation of the cell. The electrolyte is carefully dispersed into and between closely spaced layers of the electrode elements and separator layers. The electrolyte is not illustrated in the drawing figure because it is difficult to illustrate between tightly compacted electrode layers.

In accordance with embodiments of this invention, atmospheric plasmas are used in the manufacture of electrode members of lithium-ion cells.

In one embodiment of the invention, a battery electrode making process is disclosed by which an active lithium-ion cell material is deposited and bonded to a current collector by an atmospheric plasma source. More than one cell material can be deposited simultaneously and more than one layer of the cell material may be applied. Accordingly, this electrode coating can have a distribution of compositions and physical characteristics throughout the thickness so that the overall performance of the battery cell can be improved such as having a better energy/power performance and cycle life. The total coating thickness can reach up to a few hundred microns depending on the electrode materials used and plasma processing conditions. Its wide thickness range makes the process versatile for both energy and power cell applications. In contrast to the current wet-transfer coating method of making battery electrodes, by eliminating the need for slurry, wet coating, drying and pressing processes, cell manufacturing cycle time and cost can be greatly reduced.

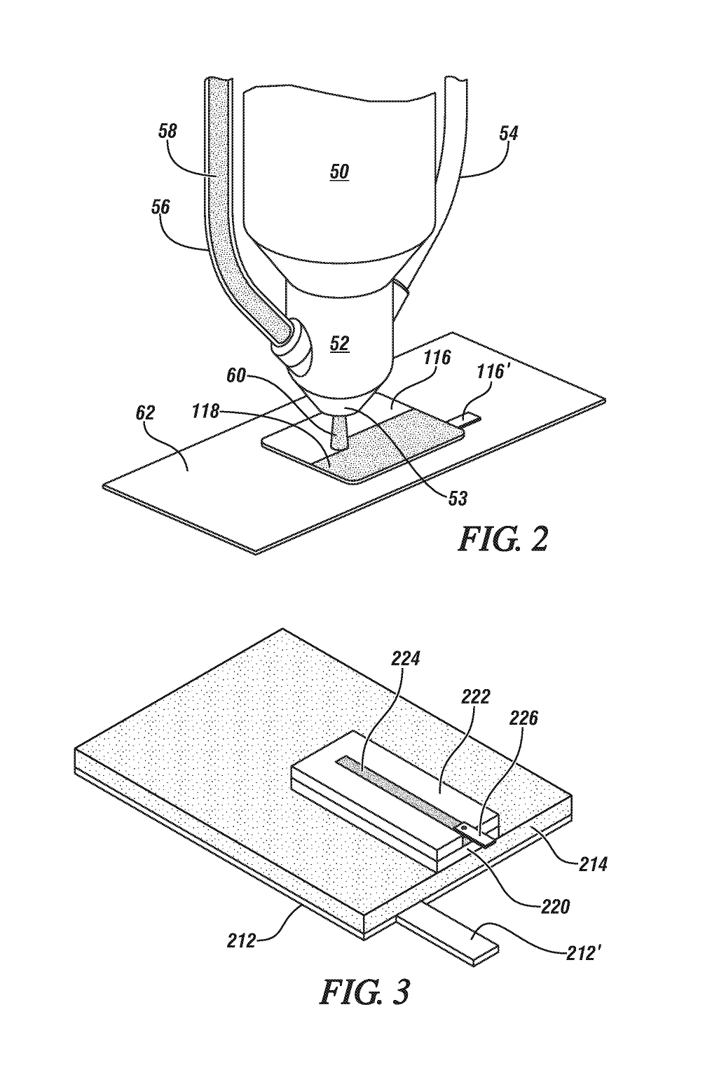

Atmospheric plasma spray methods and plasma spray nozzles are known and commercially available. In practices of this invention, and with reference to FIG. 2, an atmospheric plasma apparatus may comprise an upstream round flow chamber (shown in partly broken-off illustration at 50 in FIG. 2) for the introduction and conduct of a flowing stream of suitable working gas, such as air, nitrogen, or an inert gas such as helium or argon. In this embodiment, this illustrative initial flow chamber 50 is tapered inwardly to smaller round flow chamber 52. Particles of electrode materials 58 are delivered through supply tubes 54, 56 (tube 56 is shown partially broken-away to illustrate particles 58) and are suitably introduced into the working gas stream in chamber 52 and then carried into a plasma nozzle 53 in which the air (or other working gas) is converted to a plasma stream at atmospheric pressure. And, for example, particles of a first active material composition or morphology may be delivered through one supply tube 54 and particles of a second active material or morphology delivered through a second supply tube 56. As the particles 58 enter the gas stream they are dispersed and mixed in it and carried by it. As the stream flows through a downstream plasma-generator nozzle 53, the particles 58 are heated by the formed plasma to a deposition temperature. As stated above in this specification, the metal component of the particles is at least partially and momentarily melted in the plasma

The stream of air-based plasma and suspended electrode particle material 60 is progressively directed by the nozzle against the surface of a substrate, such as a metal current collector foil 116 for a positive electrode for a lithium-ion cell. The substrate foil 116 is supported on a suitable working surface 62 for the atmospheric plasma deposition process. The deposition substrate for the atmospheric plasma deposition is illustrated in FIG. 2 as an individual current collector foil 116 with its connector tab 116′. But it is to be understood that the substrate for the atmospheric plasma deposition may be of any size and shape for economic use and application of the plasma. For example, specified smaller working electrode members may later be cut from a larger initially coated substrate. The nozzle is moved in a suitable path and at a suitable rate such that the particulate electrode material is deposited as a layer positive electrode material 118 of specified thickness on the surface of the current collector foil 116 substrate. The plasma nozzle may be carried on a robot arm and the control of plasma generation and the movement of the robot arm be managed under control of a programmed computer. In other embodiments of the invention, the substrate is moved while the plasma is stationary.

In embodiments of this invention the particulate material (58 in FIG. 2) to be deposited by the plasma nozzle and process comprises a minor portion of relatively low melting conductive metal, such as aluminum, which is intended to be partially melted in the plasma stream so as to serve as a conductive binder for the lithium compounds that are typically used to make-up the positive electrode material.

Such plasma nozzles for this application are commercially available and may be carried and used on robot arms, under multi-directional computer control, to coat the many surfaces of each planar substrate for a lithium-ion cell module. Multiple nozzles may be required and arranged in such a way that a high coating speed may be achieved in terms coated area per unit of time.

The plasma nozzle typically has a metallic tubular housing which provides a flow path of suitable length for receiving the flow of working gas and dispersed particles of electrode material and for enabling the formation of the plasma stream in an electromagnetic field established within the flow path of the tubular housing. The tubular housing terminates in a conically tapered outlet, shaped to direct the shaped plasma stream toward an intended substrate to be coated. An electrically insulating ceramic tube is typically inserted at the inlet of the tubular housing such that it extends along a portion of the flow passage. A stream of a working gas, such as air, and carrying dispersed particles of electrode material, is introduced into the inlet of the nozzle. The flow of the air-particle mixture may be caused to swirl turbulently in its flow path by use of a swirl piece with flow openings, also inserted near the inlet end of the nozzle. A linear (pin-like) electrode is placed at the ceramic tube site, along the flow axis of the nozzle at the upstream end of the flow tube. During plasma generation the electrode is powered by a high frequency generator at a frequency of about 50 to 60 kHz (for example) and to a suitable potential of a few kilovolts. The metallic housing of the plasma nozzle is grounded. Thus, an electrical discharge can be generated between the axial pin electrode and the housing.

When the generator voltage is applied, the frequency of the applied voltage and the dielectric properties of the ceramic tube produce a corona discharge at the stream inlet and the electrode. As a result of the corona discharge, an arc discharge from the electrode tip to the housing is formed. This arc discharge is carried by the turbulent flow of the air/particulate electrode material stream to the outlet of the nozzle. A reactive plasma of the air and electrode material mixture is formed at a relatively low temperature. A copper nozzle at the outlet of the plasma container is shaped to direct the plasma stream in a suitably confined path against the surfaces of the substrates for the lithium-ion cell elements. And the plasma nozzle may be carried by a computer-controlled robot to move the plasma stream in multi-directional paths over the planar surface of the substrate material to deposit the electrode material in a continuous thin layer on the thin substrate surface layer. The deposited plasma-activated material forms an adherent porous layer of bonded electrode material particles on the current collector foil surface.

In the example illustrated in FIG. 2, a positive electrode material, such as particles of LiMnO₂ coated with a thin layer of aluminum (or mixed with particles of aluminum) was deposited on an aluminum current collector foil. The combination of metallic current collector and plasma deposited positive electrode material thus illustrate the making of individual positive electrodes for a lithium-ion cell. Negative electrodes may be made in a like manner with negative electrode material (containing copper particles or a copper coating) being deposited using the plasma on a negative electrode current collector. As stated the plasma process may be used to make individual layered electrodes or a large sheet of such electrodes from which individual electrodes may be cut or formed.

As stated above in this specification, two different active materials (varying in composition and/or morphology) may be co-deposited, one from each of two or more different delivering tubes supplying the plasma nozzle. This provides flexibility to the electrode material forming process by changing electrode material compositions from one layer to another in the plasma delivery process to change electrode properties in different layers of a multi-layer deposit on a substrate.

In another embodiment of the invention, a suitable non-electrically conductive, porous separator layer may be used as a substrate. The atmospheric plasma coating deposit does not get so hot as to damage a polymeric separator if one is used as a substrate. Electrode materials may be deposited on the separator membrane substrate in a suitable pattern. And a current collector layer may be deposited by atmospheric plasma in a suitable pattern on the electrode material layer.

FIG. 3 illustrates a further embodiment of this invention. In many assemblies of lithium ion cells it is desirable to insert a reference electrode which is employed in diagnosis and management (often computer-based management) of the performance of the battery. Such a reference electrode comprises a metal conductor strip or film bonded to a suitable reference electrode material for intermittent, electrical connection with working electrodes of the battery to assess their present performance. In this example, the process may start with an existing negative electrode current collector foil 212 (with its connection tab 212′) and co-extensive coating of negative electrode material 214. Of course, this layered negative electrode structure may have been prepared by the subject atmospheric plasma process. A porous separator layer 220 (typically about 5 to 30 microns thick and illustrated as rectangular in FIG. 3) is placed on a selected region of the layer (typically about 5 to 200 microns thick) of negative electrode material 214, preferably adjacent the side of the current collector foil 212 carrying its connector tab 212′.

A copper or aluminum conductor bar 224 is to be deposited in a relatively thin strip along the exposed face of separator layer 220. A removable mask 222 is applied over the exposed surface of the separator layer 220. The mask is shaped with an opening defining the desired shape of the conductor bar 224. An atmospheric plasma delivering partially melted copper particles is used to form a deposit of an electrically conductive copper strip 224 on a portion of the surface of separator layer 220. In a preferred embodiment, the thickness of the deposited copper foil is about one to twenty micrometers. And, the width of the conductor strip is about five to twenty micrometers and its length is about five millimeters. The separator is at least five times wider and two times longer than the deposited conductor strip. The deposited conductor strip is to serve as a current collector for a reference electrode to be formed as described below in this specification.

Following the deposition of the copper conductor strip 224, the mask 222 is removed from the separator 220 surface, leaving only the conductor strip 224 on the outer surface of the separator 220. A connector tab 226 (for example a nickel tab) is welded to the end of the conductor strip lying at the edge of the separator.

The, thus prepared, separator 220 and negative electrode structure 212, 214 are assembled into a cell assembly by covering the copper conductor strip 224 with another separator. An opposing positive electrode is placed against the covering separator to place the copper conductor strip between the two opposing electrodes, and an electrolyte is injected into the assembled electrodes and separators. A suitable electrical connection may be made between the reference electrode and one or the working electrodes The cell is then operated to electrochemically transfer a small amount of lithium from a working electrode and to electrochemically plate the transferred lithium (as reference electrode material) on the plasma deposited copper strip. The now formed reference electrode may then be connected as desired (using nickel tab 226) to other electrode connectors for assessing working electrode activities and performance.

Thus, methods of using atmospheric plasma have been provided to form layered electrode materials and current collectors for working electrodes and reference electrodes in lithium-ion cells. The plasma method enables the formation of working material layers of up to about two hundred micrometers in thickness to increase the capacity of the electrodes. And the process avoids the use of extraneous binders of polymers and the need for wet process application of electrode materials to their current collector substrates.

It is recognized that the use of an atmospheric plasma may also be utilized in forming anode materials and current collectors for lithiated silicon-sulfur secondary batteries. Lithiated silicon-sulfur cells typically comprise a lithiated silicon-based anode, a lithium polysulfide electrolyte, a porous separator layer and a sulfur-based cathode. A layer of silicon based materials, including, for example, silicon, silicon alloys, and silicon-graphite composites, up to about 200 microns in thickness is deposited on a metal current collector in the formation of an anode layer. Atmospheric plasma deposition processes, like those described for the preparation of layered electrode members of lithium-ion cells may be used in making analogous electrode structures for lithiated silicon-sulfur cells.

The examples that have been provided to illustrate practices of the invention are not intended as limitations on the scope of such practices.

1. A method of forming an electrode member of a lithium-ion electrochemical cell, the formed electrode member comprising at least two bonded sheet layers, the method comprising:
adding solid particles of lithium-ion cell electrode material to a flowing gas stream, the solid particles consisting essentially of (i) particles of an electrically conductive metal or of (ii) particles of a lithium-ion cell electrode material combined with an amount of electrically conductive metal for bonding of the particles of electrode material, the solid particles being dispersed and carried in the flowing gas stream;
generating an atmospheric plasma in the gas stream to heat the solid particles by the plasma and to at least partially melt the electrically conductive metal; and
directing the atmospheric plasma, containing the heated solid particles, against a selected surface of a substrate, while moving at least one of the directed plasma and the selected surface of the substrate with respect to the other, to deposit the plasma-heated solid particles in a sheet layer of predetermined thickness and porosity on the selected surface area of the substrate, the conductive metal re-solidifying to bond the solid particles to each other in the sheet layer and to bond the sheet layer to the substrate; the substrate being a sheet layer portion of an electrode member of a lithium-ion electrochemical cell or a separator membrane member of a lithium-ion electrochemical cell, the final sheet thickness of deposited plasma-heated solid particles on the selected area of the substrate being up to about two hundred micrometers and comprising one or more sheet layers of such deposited plasma-heated solid particles.

2. The method of claim 1 in which the plasma is moved relative to the selected surface of the substrate to deposit at least one additional layer of plasma-heated solid particles over a previously deposited layer of solid particles bonded to the surface of the substrate.

3. The method of claim 2 in which the composition, porosity, morphology, or thickness of the at least one additional deposited layer is different from that of the previously deposited layer.

4. The method of claim 1 in which particles of a lithium-ion cell electrode material, combined with an electrically conductive metal, are deposited on a substrate which is a current collector layer of an electrode member of a lithium-ion electrochemical cell.

5. The method of claim 1 in which particles of at least one composition selected from the group consisting of graphite, silicon particles, silicon alloy particles, silicon oxide particles, lithium-silicon particles, lithium-tin particles, and lithium titanate particles, are combined with copper and deposited on a substrate which is a copper current collector layer of an electrode member of a lithium-ion electrochemical cell.

6. The method of claim 1 in which particles of an oxide compound of lithium and at least one other metal element are combined with aluminum and deposited on a substrate which is an aluminum current collector layer of an electrode member of a lithium-ion electrochemical cell.

7. The method of claim 1 in which particles of copper or aluminum are deposited as a current collector layer on substrate which is an electrode material layer of a lithium-ion electrochemical cell.

8. A method of forming an electrode member of a lithium-ion electrochemical cell, the method comprising:
adding solid particles of lithium-ion cell electrode material to a flowing gas stream, the solid particles consisting essentially of particles of a lithium-ion cell electrode material combined with an electrically conductive metal, the solid particles being dispersed and carried in the flowing gas stream;
generating an atmospheric plasma in the gas stream to heat the solid particles by the plasma and to at least partially melt the electrically conductive metal; and
directing the plasma stream and heated solid particles against a metal current collector substrate layer, while moving at least one of the directed plasma and the current collector substrate layer with respect to the other, to deposit the plasma-heated solid particles in a sheet layer of predetermined thickness and porosity on a selected surface area of the metal current collector substrate layer, the conductive metal re-solidifying to bond the solid particles to each other and to the metal current collector substrate layer, the bonded solid particles forming a layer of lithium-ion cell electrode material on the metal current collector substrate, the lithium-ion electrode material having a thickness up to about two hundred micrometers.

9. The method of claim 8 in which the selected surface area of the formed layer of lithium-ion cell electrode material is coextensive with the metal current collector substrate, except for any portion of the current collector substrate shaped for electrical connection to another lithium-ion cell member.

10. The method of claim 8 in which the plasma stream is directed and moved relative to the surface of the metal current collector substrate to deposit at least one additional layer of plasma-heated solid particles over a previously deposited layer of solid particles.

11. The method of claim 10 in which the composition, morphology, porosity, or thickness of the at least one additional layer is different from that of the previously deposited layer.

12. The method of claim 8 in which particles of at least one composition, selected from the group consisting of graphite, silicon particles, silicon alloy particles, silicon oxide particles, lithium-silicon particles, lithium-tin particles, and lithium titanate particles, are combined with copper and deposited on a copper current collector layer of an electrode member of a lithium-ion electrochemical cell.

13. The method of claim 8 in which particles of an oxide compound of lithium and at least one other metal element are combined with aluminum and deposited on an aluminum current collector layer of an electrode member of a lithium-ion electrochemical cell.

14. The method of claim 8 in which the metal current collector substrate layer is formed by the plasma deposition on a selected surface area of a separator membrane for use in the same lithium-ion electrochemical cell.

15. A method of forming an electrode member of a lithium-ion electrochemical cell, the method comprising:
adding solid particles of copper or aluminum to a flowing gas stream, the solid particles being dispersed and carried in the flowing gas stream;
generating an atmospheric plasma in the gas stream, the plasma heating the solid particles and at least partially melting the copper or aluminum particles;
directing the plasma against a selected surface area of a separator membrane substrate layer, while moving the plasma relative to the selected surface area of the separator membrane, to deposit the plasma-heated copper or aluminum particles in a layer on a selected surface area of the separator membrane substrate layer, the copper or aluminum particles re-solidifying to bond to each other and to the separator membrane substrate layer, the bonded copper or aluminum particles forming a current collector layer of on the selected surface area of the separator membrane substrate and having a thickness up to about twenty micrometers;
assembling the separator membrane, with its current collector layer, into a lithium-ion electrochemical cell;
operating the assembled lithium-ion cell to transfer lithium from an electrode member of the cell and to deposit the lithium as a layer of reference electrode material on the surface of the plasma-deposited, copper or aluminum current collector layer; and, thereafter
operating the lithium-ion cell using the reference electrode material to assess the function of electrode members of the cell.

16. The method of claim 15 in which a removable masking material is applied to the separator membrane layer substrate to define the selected surface area on the substrate for the atmospheric plasma deposition of the copper or aluminum current collector, and the mask is removed following deposition of the current collector layer.

17. The method of claim 16 in which a metal connector tab is welded to an end of the deposited copper or aluminum current collector layer to enable electrical connection of the current collector layer with another electrode member of the cell.

18. The method of claim 16 in which the removable mask defines a surface area for the deposition of the copper or aluminum on the total area of the separator membrane layer substrate such that the uncoated area of the separator membrane is at least five-times the width and two-times the length of the area of the deposition of the copper or aluminum current collector.

19. A method of forming the anode member of a lithiated silicon-sodium electrochemical cell, the formed electrode member comprising a bonded sheet layer, the method comprising:
adding solid particles of lithiated silicon-sulfur cell anode material to a flowing gas stream, the solid particles consisting essentially of (i) particles of an electrically conductive metal or of (ii) particles of cell anode material combined with an amount of electrically conductive metal for bonding of the particles of anode material, the solid particles being dispersed and carried in the flowing gas stream;
generating an atmospheric plasma in the gas stream to heat the solid particles by the plasma and to at least partially melt the electrically conductive metal; and
directing the atmospheric plasma, containing the heated solid particles, against a selected surface of a substrate, while moving at least one of the directed plasma and the selected surface of the substrate with respect to the other, to deposit the plasma-heated solid particles in a sheet layer of predetermined thickness and porosity on the selected surface area of the substrate, the conductive metal re-solidifying to bond the solid particles to each other in the sheet layer and to bond the sheet layer to the substrate; the substrate being a sheet layer portion of an anode of a lithiated silicon-sulfur electrochemical cell or a separator membrane member of a lithiated silicon-sulfur electrochemical cell, the final sheet thickness of deposited plasma-heated solid particles on the selected area of the substrate being up to about two hundred micrometers and comprising one or more sheet layers of such deposited plasma-heated solid particles.

20. The method of claim 19 in which the plasma is moved relative to the selected surface of the substrate to deposit at least one additional layer of plasma-heated solid particles over a previously deposited layer of solid particles bonded to the surface of the substrate.
